(19) United States
(12) Patent Application Publication
(10) Pub. No.: US 2025/0175549 A1
(43) Pub. Date: May 29, 2025

(54) ELECTRONIC APPARATUS

(71) Applicant: SONY GROUP CORPORATION, TOKYO (JP)

(72) Inventors: JOSUKE KAWASHIMO, TOKYO (JP); WATARU NAKANO, TOKYO (JP)

(21) Appl. No.: 18/843,594

(22) PCT Filed: Jan. 13, 2023
(86) PCT No.: PCT/JP2023/000755

§ 371 Date: Sep. 3, 2024

(30) Foreign Application Priority Data
Mar. 7, 2022 (JP) 2022-034659

(51) Int. Cl. H04M 1/18

(52) U.S. Cl. CPC H04M 1/18

(57) ABSTRACT

[Object] To provide a waterproof electronic apparatus, a part of which pops up from a main body portion thereof. Solving Means] The electronic apparatus includes: a main body portion that includes a first component; a pop-up portion that includes a second component and is capable of being housed in the main body portion and capable of popping up from the main body portion in a first direction; a shaft unit including a sleeve that is movably connected to one of the main body portion and the pop-up portion and fixedly connected to another one of the main body portion and the pop-up portion and is movable in the first direction, and a tunnel that penetrates the sleeve in the first direction, the shaft unit moving the pop-up portion in the first direction relative to the main body portion; and a cable unit that passes through the tunnel to connect the first component and the second component to each other.

### TECHNICAL FIELD

The present disclosure relates to an electronic apparatus such as a smartphone.

### BACKGROUND ART

An electronic apparatus, a part of which pops up from a main body portion thereof, is proposed (Patent Literature 1).

### CITATION LIST

### Patent Literature

Patent Literature 1: WO2020/095387

### DISCLOSURE OF INVENTION

### Technical Problem

Patent Literature 1 does not disclose that an electronic apparatus, a part of which pops up from a main body portion thereof, is made waterproof.

In view of the circumstances as described above, an electronic apparatus, a part of which pops up from a main body portion thereof, is made waterproof.

### Solution to Problem

An electronic apparatus according to one embodiment of the present disclosure includes:
a main body portion that includes a first component;
a pop-up portion that includes a second component and is capable of being housed in the main body portion and capable of popping up from the main body portion in a first direction;
a shaft unit including
   a sleeve that is movably connected to one of the main body portion and the pop-up portion and fixedly connected to another one of the main body portion and the pop-up portion and is movable in the first direction, and
   a tunnel that penetrates the sleeve in the first direction,
the shaft unit moving the pop-up portion in the first direction relative to the main body portion; and
a cable unit that passes through the tunnel to connect the first component and the second component to each other.

In this embodiment, in the structure in which the pop-up portion and the main body portion are connected to each other, the cable unit passes through the tunnel of the shaft unit, and thus the compatibility between the waterproof property at the connection location and the downsizing or reduction in thickness can be achieved.

The shaft unit may further include
an operating portion that moves the pop-up portion in the first direction relative to the main body portion, and
a shaft housing portion that penetrates the sleeve in the first direction and houses the operating portion, and
in a cross-section of the shaft unit, the cross-section being orthogonal to the first direction,
the tunnel and the shaft housing portion may be adjacent to each other in a second direction orthogonal to the first direction, and
in a third direction orthogonal to the first direction and the second direction, both ends of the tunnel in the third direction may be matched with or located inwardly relative to both ends of the shaft housing portion in the third direction.

It is possible to set the length of the sleeve to be a minimum length that allows the operating portion to be housed, and possible to prevent the sleeve from being increased in size (that is, the electronic apparatus from being increased in thickness).

In the cross-section of the shaft unit, the cross-section being orthogonal to the first direction,
the shaft housing portion may be circular,
the tunnel may include a first end portion on a distant side of the tunnel from the shaft housing portion, and
the first end portion may include a first arc portion in which a distance in the second direction from the shaft housing portion is constant over a predetermined section in the third direction.

Accordingly, the sleeve having the limited size is provided with a space of the shaft housing portion, and then the area of the tunnel is maximized. Specifically, the tunnel is formed in a shape close to a crescent shape as a whole, and thus the region between the shaft housing portion and the tunnel can be used without waste, and the tunnel can have a maximum area without increasing the size of the sleeve.

In the cross-section of the shaft unit, the cross-section being orthogonal to the first direction,
the tunnel may include a second end portion on a distant side of the tunnel from the shaft housing portion, and
the second end portion may include a second arc portion in which a distance in the second direction from the shaft housing portion is constant over a predetermined section in the third direction.

Accordingly, the sleeve having the limited size is provided with a space of the shaft housing portion, and then the area of the tunnel is maximized.

The cable unit may include a cable and a connector that connects the cable to the first component or the second component.

The electronic apparatus may include two cable units that are a first cable unit and a second cable unit.

A maximum width of the tunnel in the second direction may be shorter than a sum of a diameter of the cable of the first cable unit and a shorter length of lengths of the connector of the second cable unit in two directions orthogonal to a direction in which the connector of the second cable unit is inserted into the tunnel.

It is possible to insert the first cable unit and the second cable unit into the tunnel, irrespective of the fact that the tunnel has such a size that the connector of the second cable unit and the cable of the first cable unit cannot be inserted in the state of overlapping with each other.

The shorter length of the lengths of the connector of the second cable unit in the two directions may be a length of the connector of the second cable unit in a fitting direction relative to the first component or the second component.

In a cross-section of the shaft unit, the cross-section being orthogonal to the first direction,
the tunnel may include
   a cable region in which the cable of the first cable unit is housed, and
   a connector region in which the connector of the second cable unit is inserted in a state in which the cable of the first cable unit is housed in the cable region, and
a boundary line between the cable region and the connector region may incline relative to the second direction and the third direction.

This makes it possible to insert the first cable unit and the second cable unit into the tunnel, irrespective of the fact that the tunnel has such a size that the connector of the second cable unit and the cable of the first cable unit cannot be inserted in the state of overlapping with each other.

The first component may be a substrate, and
the second component may be an antenna unit.

Accordingly, the antenna unit disposed in the pop-up portion and the main substrate incorporated into the main body portion need to be connected to and be electrically conducted with each other via an antenna cable unit. In such a structure, the compatibility between the ensuring of waterproof property at the connection location of the pop-up portion and the main body portion and the downsizing or reduction in thickness can be achieved.

The main body portion and the pop-up portion may be waterproof.

In the structure in which the pop-up portion and the main body portion are connected to each other, the ensuring of waterproof property at the connection location and the downsizing or reduction in thickness of the electronic apparatus are in a trade-off relationship. In this embodiment, in the structure in which the pop-up portion and the main body portion are connected to each other, the compatibility between the ensuring of waterproof property at the connection location and the downsizing or reduction in thickness can be achieved.

The electronic apparatus may further include:
a first waterproof component provided between the main body portion and the sleeve; and
a second waterproof component provided between the pop-up portion and the sleeve.

Preventing the sleeve from being increased in size makes it possible to prevent the first waterproof component and the second waterproof component from being increased in size and installation locations thereof from being widened. In other words, the first waterproof component and the second waterproof component can be reduced in size, and the number of first waterproof components and second waterproof components can be reduced to be minimum. This is space-saving and contributes to the downsizing or reduction in thickness of the electronic apparatus. Further, the number of locations in which the first waterproof component and the second waterproof component are installed is minimized, and the area thereof is made small, so that a location in which the waterproof property may attenuate can be reduced and the area thereof can be made small accordingly.

A surface orthogonal to the first direction of the main body portion may be covered with the pop-up portion.

Accordingly, the antenna unit needs to be disposed in the pop-up portion. The antenna unit disposed in the pop-up portion and the main substrate incorporated into the main body portion need to be connected to and be electrically conducted with each other via an antenna cable unit. In such a structure, the compatibility between the ensuring of waterproof property at the connection location of the pop-up portion and the main body portion and the downsizing or reduction in thickness can be achieved.

The pop-up portion may include a speaker, a camera lens, and/or a microphone.

The electronic apparatus may further include:
two of the pop-up portion that face each other in the first direction relative to the main body portion; and
two of the shaft unit and two sets of the cable unit that are provided to the respective two pop-up portions.

The two pop-up portions are not only capable of simultaneously popping up but also capable of popping up independently separately from each other such that one of them enters a pop-up state.

### BRIEF DESCRIPTION OF DRAWINGS

FIG. 1 is a perspective view of an electronic apparatus (housed state) according to one embodiment of the present disclosure.

FIG. 2 is a perspective view of the electronic apparatus (pop-up state).

FIG. 3 schematically shows an internal structure of the electronic apparatus (housed state).

FIG. 4 schematically shows an internal structure of the electronic apparatus (pop-up state).

FIG. 5 is a cross-sectional view showing a cross-section orthogonal to the Z-direction of a shaft unit.

FIG. 6 is a perspective view of a connector of a cable unit.

FIG. 7 is a front view of the connector of the cable unit.

FIG. 8 schematically shows a connector of a first cable unit and a cable of a second cable unit.

FIG. 9 is a diagram for describing a state in which the two cable units are inserted into a tunnel.

### MODE(S) FOR CARRYING OUT THE INVENTION

Hereinafter, an embodiment of the present disclosure will be described with reference to the drawings.

### 1. General Outline of Electronic Apparatus

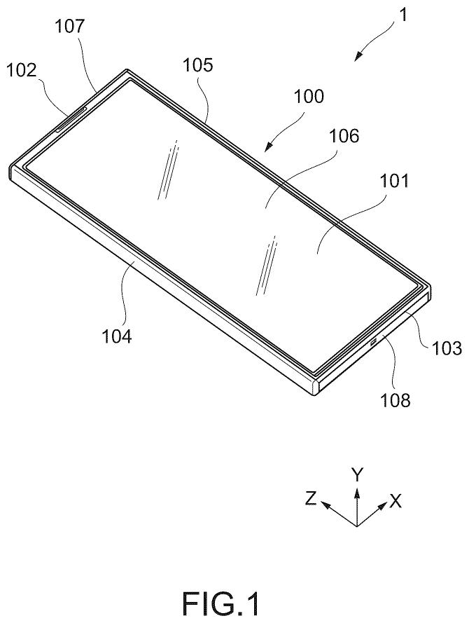

FIG. 1 is a perspective view of an electronic apparatus (housed state) according to one embodiment of the present disclosure.

In this embodiment, an electronic apparatus 1 will be described as a smartphone. Note that the electronic apparatus 1 may be another mobile device such as a tablet computer, a personal computer, or a personal digital assistant (PDA).

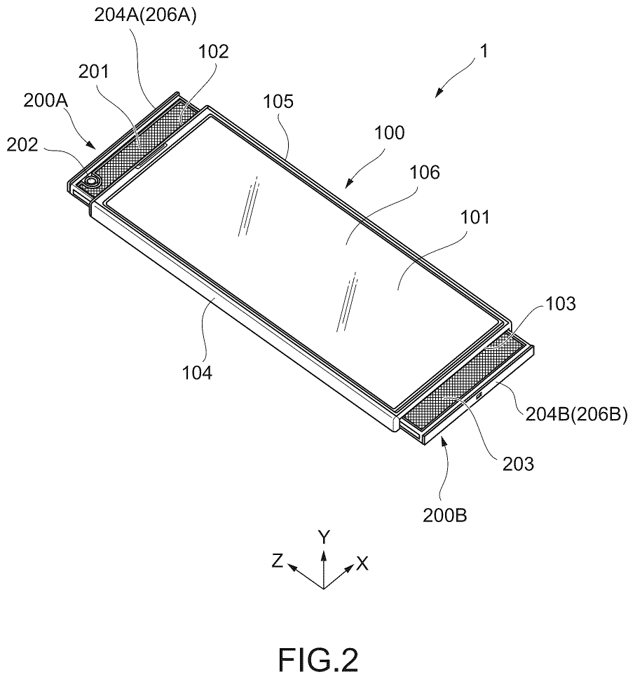

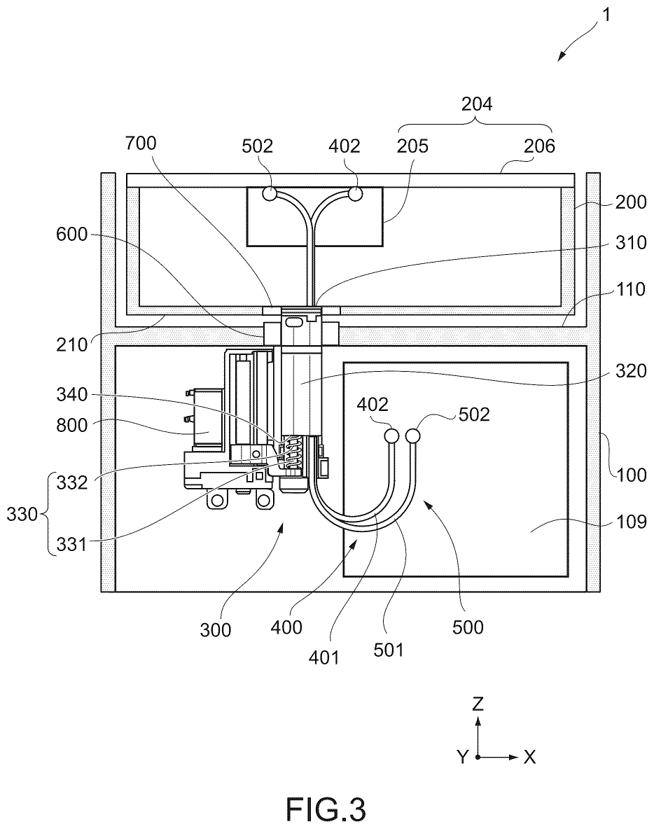

The electronic apparatus 1 typically has a thin rectangular parallelepiped shape or substantially rectangular parallelepiped shape (e.g., a rectangular parallelepiped shape having rounded corners). The electronic apparatus 1 includes a main body portion 100. The main body portion 100 includes (incorporates) a main substrate 109 (first component) (FIGS. 2 and 3). The main body portion 100 has an outer appearance shape that is equal or substantially equal to the outer appearance shape of the electronic apparatus 1. A main surface 101 of the main body portion 100 has a rectangular shape or a substantially rectangular shape and has short sides 102 and 103 facing each other and long sides 104 and 105 facing each other. A touch panel 106 is provided to the substantially entire region of the main surface 101 of the main body portion 100. The electronic apparatus 1 has a top surface 107 including one short side 102 of the main surface 101, and a bottom surface 108 including the other short side 103 of the main surface 101. The top surface 107 and the bottom surface 108 correspond to two facing surfaces of the electronic apparatus 1 having a rectangular parallelepiped shape or a substantially rectangular parallelepiped shape.

Hereinafter, a direction in which the long sides 104 and 105 of the main body portion 100 extend (a direction in which the short sides 102 and 103 face each other) will be referred to as a Z-direction (first direction). A direction that is orthogonal to the Z-direction and in which the short sides 102 and 103 of the main body portion 100 extend (a direction in which the long sides 104 and 105 face each other) will be referred to as an X-direction (second direction). A direction orthogonal to the main surface 101 of the main body portion 100 (a direction orthogonal to the X-direction and the Z-direction) will be referred to as a Y-direction (third direction).

FIG. 2 is a perspective view of the electronic apparatus (pop-up state).

The electronic apparatus 1 includes two pop-up portions 200A and 200B that face each other in the Z-direction relative to the main body portion 100. In other words, the electronic apparatus 1 includes a top-side pop-up portion 200A provided to the top surface 107 and a bottom-side pop-up portion 200B provided to the bottom surface 108. A surface of the main body portion 100 on the top surface 107 side is covered with the top-side pop-up portion 200A. A surface of the main body portion 100 on the bottom surface 108 side is covered with the bottom-side pop-up portion 200B.

The main body portion 100, the top-side pop-up portion 200A, and the bottom-side pop-up portion 200B each have waterproof property. For example, the members are attached to each other using a waterproof adhesive, or a rubber seal is installed on a member (SIM tray etc.) to which another member is to be detachably mounted, so that the main body portion 100, the top-side pop-up portion 200A, and the bottom-side pop-up portion 200B are provided with waterproof property.

The top-side pop-up portion 200A includes a speaker 201 and a camera lens 202. The bottom-side pop-up portion 200B includes a speaker 203. The top-side pop-up portion 200A and/or the bottom-side pop-up portion 200B include(s) a microphone (not shown).

The top-side pop-up portion 200A includes a top-side antenna unit 204A (second component). A top-side antenna metal 206A of the top-side antenna unit 204A corresponds to the entire region or the substantially entire region of the top surface 107 of the electronic apparatus 1. The bottom-side pop-up portion 200B includes a bottom-side antenna unit 204B (second component). A bottom-side antenna metal 206B of the bottom-side antenna unit 204B corresponds to the entire region or the substantially entire region of the bottom surface 108 of the electronic apparatus 1.

The top-side pop-up portion 200A and the bottom-side pop-up portion 200B are capable of being housed in the main body portion 100 (FIG. 1), and capable of popping up from the main body portion 100 in the Z-direction from the state of being housed in the main body portion 100 (FIG. 2). Hereinafter, the state in which the top-side pop-up portion 200A and the bottom-side pop-up portion 200B are housed in the main body portion 100 (FIG. 1) will be referred to as a housed state, and the state in which the top-side pop-up portion 200A and the bottom-side pop-up portion 200B pop up from the main body portion 100 in the Z-direction (FIG. 2) will be referred to as a pop-up state. The top-side pop-up portion 200A and the bottom-side pop-up portion 200B are not only capable of simultaneously popping up (FIG. 2) but also capable of popping up independently separately from each other such that one of them enters a pop-up state.

The top-side pop-up portion 200A and the bottom-side pop-up portion 200B have a similar structure, and thus hereinafter the top-side pop-up portion 200A and the bottom-side pop-up portion 200B will be collectively referred to simply as a pop-up portion 200, and a single pop-up portion 200 will be described below and shown in the figures. Similarly, the top-side antenna unit 204A and the bottom-side antenna unit 204B have a similar structure, and thus hereinafter the top-side antenna unit 204A and the bottom-side antenna unit 204B will be collectively referred to simply as an antenna unit 204, and a single antenna unit 204 will be described below and shown in the figures. Similarly, the top-side antenna metal 206A and the bottom-side antenna metal 206B have a similar structure, and thus hereinafter the top-side antenna metal 206A and the bottom-side antenna metal 206B will be collectively referred to simply as an antenna metal 206, and a single antenna metal 206 will be described below and shown in the figures.

### 2. Concept of Electronic Apparatus

The part corresponding to the long sides 104 and 105 of the electronic apparatus 1 (smartphone) is often held with the hand of a user or is covered with a cover or case when the electronic apparatus 1 is used. For that reason, typically, in order to achieve high antenna performance (antenna gain), the antenna unit 204 for antenna based on communication standards in which high performance (high gain) is requested is disposed on each of the top surface 107 and the bottom surface 108 (that are relatively less frequently held with the hand or covered with a cover or the like) of the electronic apparatus 1.

In this embodiment, as described above, the pop-up portion 200 corresponds to the entire region or substantially entire region of one surface (top surface 107 or bottom surface 108) of the electronic apparatus 1. Thus, the antenna unit 204 needs to be disposed in the pop-up portion 200. Additionally, the antenna unit 204 disposed in the pop-up portion 200 and the main substrate 109 incorporated into the main body portion 100 need to be connected to and be electrically conducted with each other via an antenna cable unit.

Incidentally, there are many demanders who desire an electronic apparatus 1 such as a smartphone having waterproof property. Typically, in order to provide the electronic apparatus 1 with waterproof property, the members are attached to each other using a waterproof adhesive, or a rubber seal is installed on a member (SIM tray etc.) to which another member is to be detachably mounted.

Meanwhile, in this embodiment, the antenna unit 204 disposed in the pop-up portion 200 and the main substrate 109 incorporated into the main body portion 100 need to be connected to and be electrically conducted with each other via an antenna cable unit. The compatibility between this connection and the waterproof property will be considered.

As an example, it is assumed that a through-hole through which the antenna cable unit passes is provided to each of the main body portion 100 and the pop-up portion 200. In order to provide the waterproof property to the through-holes of the main body portion 100 and the pop-up portion 200, it is conceivable that the through-holes are each liquid-tightly sealed with a rubber seal (O-ring). However, the rubber seal installed at the through-hole takes up a space, which may hinder downsizing or a reduction in thickness of the electronic apparatus 1. Further, the fact that there are many locations where the rubber seal is installed and that the area thereof is large means that there are many locations where the waterproof property attenuates and the area thereof is large accordingly. Thus, it is recommended to provide the rubber seal at a small number of locations and in a narrow region.

As another example, it is assumed that the antenna unit 204 disposed in the pop-up portion 200 and the main substrate 109 incorporated into the main body portion 100 are connected to each other by a flexible printed board having waterproof property. However, the location where the flexible printed board is installed takes up a space, which may hinder downsizing or a reduction in thickness of the electronic apparatus 1.

In such a manner, in the structure in which the pop-up portion 200 and the main body portion 100 are connected to each other, the ensuring of waterproof property at the connection location and the downsizing or reduction in thickness of the electronic apparatus 1 are in a trade-off relationship. In view of the circumstances as described above, in this embodiment, in the structure in which the pop-up portion 200 and the main body portion 100 are connected to each other, the compatibility between the ensuring of waterproof property at the connection location and the downsizing or reduction in thickness is achieved.

### 3. Structure of Electronic Apparatus

FIG. 3 schematically shows an internal structure of the electronic apparatus (housed state). The electronic apparatus 1 includes, in addition to the main body portion 100 and the pop-up portion 200, a shaft unit 300, a first cable unit 500 and a second cable unit 400 that are two cable units, a first waterproof component 600, a second waterproof component 700, and a motor 800 such as a stepping motor.

The shaft unit 300 is driven by the motor 800 to move the pop-up portion 200 in the Z-direction relative to the main body portion 100, and thus causes the pop-up portion 200 to pop up from the main body portion 100. The shaft unit 300 includes a sleeve 320 and an operating portion 330. The sleeve 320 includes a shaft housing portion 340 that is hollow and cylindrical and penetrates in the Z-direction, and a hollow tunnel 310 that penetrates in the Z-direction.

The shaft housing portion 340 of the sleeve 320 houses the operating portion 330. The operating portion 330 includes a columnar shaft 331 and a coil spring 332 wound around the shaft 331. The operating portion 330 is driven by the motor 800 to move up and down in the Z-direction together with the sleeve 320.

The tunnel 310 of the sleeve 320 houses the first cable unit 500 and the second cable unit 400 that are two cable units.

The first cable unit 500 and the second cable unit 400 pass through the tunnel 310 to connect the main substrate 109 and the antenna unit 204 to each other. The antenna unit 204 includes the antenna metal 206 and an antenna board 205 that is connected to and is electrically conducted with the antenna metal 206. The antenna board 205 is, for example, a flexible printed board. The first cable unit 500 and the second cable unit 400 are connected to the antenna board 205.

The second cable unit 400 includes a cable 401 and two connectors 402 and 402 that connect the cable 401 to the main substrate 109 and to the antenna board 205 of the antenna unit 204. Hereinafter, the two connectors 402 and 402 will be simply referred to as a connector 402 if they are not distinguished from each other, and will be described assuming that the connector 402 is connected to the antenna board 205.

The first cable unit 500 includes a cable 501 and two connectors 502 and 502 that connect the cable 501 to the main substrate 109 and to the antenna board 205 of the antenna unit 204. Hereinafter, the two connectors 502 and 502 will be simply referred to as a connector 502 if they are not distinguished from each other, and will be described assuming that the connector 502 is connected to the antenna board 205.

The first cable unit 500 and the second cable unit 400 may have an equal size or a different size.

The sleeve 320 is movably connected to one of the main body portion 100 and the pop-up portion 200 and is fixedly connected to the other one of the main body portion 100 and the pop-up portion 200. Specifically, the sleeve 320 is movably connected to a casing end portion 110 (part facing the pop-up portion 200) of the main body portion 100 via the first waterproof component 600. The sleeve 320 is fixedly connected to a casing end portion 210 (part facing the main body portion 100) of the pop-up portion 200 via the second waterproof component 700. The sleeve 320 is movable in the Z-direction.

The first waterproof component 600 is, for example, an O-ring (rubber seal) and is provided between the casing end portion 110 of the main body portion 100 and the sleeve 320. The first waterproof component 600 liquid-tightly seals a gap between the casing end portion 110 of the main body portion 100 and the sleeve 320 and provides waterproof property to a connection boundary between the main body portion 100 and the sleeve 320.

The second waterproof component 700 is, for example, an O-ring (rubber seal) and is provided between the casing end portion 210 of the pop-up portion 200 and the sleeve 320. The second waterproof component 700 liquid-tightly seals a gap between the casing end portion 210 of the pop-up portion 200 and the sleeve 320 and provides waterproof property to a connection boundary between the pop-up portion 200 and the sleeve 320.

The first waterproof component 600 provides waterproof property to the connection boundary between the main body portion 100 and the sleeve 320, and the second waterproof component 700 provides waterproof property to the connection boundary between the pop-up portion 200 and the sleeve 320, so that the first cable unit 500 and the second cable unit 400 that pass through the tunnel 310 of the sleeve 320 also have waterproof property.

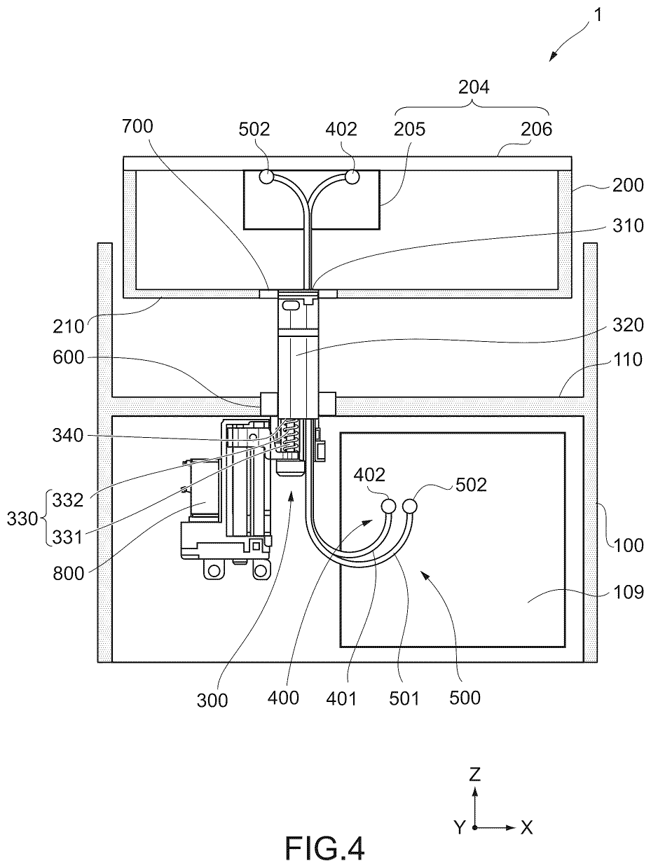

FIG. 4 schematically shows an internal structure of the electronic apparatus (pop-up state).

When the operating portion 330 of the shaft unit 300 is driven by the motor 800, the sleeve 320 moves in the Z-direction together with the operating portion 330. The sleeve 320 slides within the first waterproof component 600 that is provided to the main body portion 100 movably connected to the sleeve 320, and pushes up the pop-up portion 200 fixedly connected to the sleeve 320. Consequently, the shaft unit 300 pushes up the pop-up portion 200 in the Z-direction relative to the main body portion 100 and causes the pop-up portion 200 to pop up.

In the pop-up state in which the pop-up portion 200 completely pops up (FIG. 4), the sleeve 320 maintains the connection with the first waterproof component 600 without separating from the first waterproof component 600 provided to the main body portion 100. Consequently, in the pop-up state, one end of the sleeve 320 is connected to the first waterproof component 600, and the other end of the sleeve 320 is connected to the second waterproof component 700.

Accordingly, also in the pop-up state in addition to the housed state, the waterproof property of the main body portion 100 and the sleeve 320 and the waterproof property of the pop-up portion 200 and the sleeve 320 are maintained. Further, in the housed state and the pop-up state, further in the transition between the housed state and the pop-up state, the first cable unit 500 and the second cable unit 400 passing through the tunnel 310 of the sleeve 320 are not exposed from the tunnel 310. Therefore, in the housed state and the pop-up state, further in the transition between the housed state and the pop-up state, the waterproof property of the first cable unit 500 and the second cable unit 400 is maintained.

### 4. Structure of Sleeve

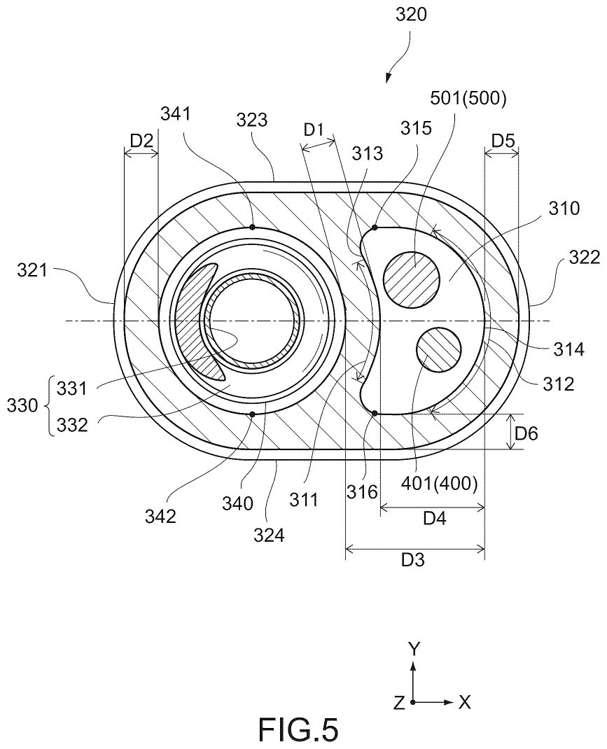

FIG. 5 is a cross-sectional view showing a cross-section of the shaft unit that is orthogonal to the Z-direction.

Next, the structure of the sleeve 320, specifically, a relationship between the shaft housing portion 340, the tunnel 310, and the first cable unit 500 and second cable unit 400 housed in the tunnel 310 will be described in detail. Hereinafter, unless otherwise noted, the structure of the sleeve 320 or the like in the cross-section of the shaft unit 300 that is orthogonal to the Z-direction (XY cross-section) will be described.

A whole shape of the sleeve 320 gives an impression of a substantially rectangular shape having long sides 323 and 324 in the X-direction and short sides 321 and 322 in the Y-direction, and both the short sides 321 and 322 bulge in an arc shape. In this embodiment, “arc” means a circular arc, an elliptical arc, or a shape close to them. For example, the maximum length of the sleeve 320 in the X-direction is 5.7 mm, and the maximum length thereof in the Y-direction is 3.7 mm. The tunnel 310 and the shaft housing portion 340 are adjacent to each other in the X-direction via a rib 317.

The shaft housing portion 340 is circular. For example, the shaft housing portion 340 has a diameter of 2.7 mm. A distance D2 between the shaft housing portion 340 and the arc-like short side 321 of the sleeve 320 is, for example, 0.5 mm. Thus, in the state in which the shaft housing portion 340 and the arc-like short side 321 of the sleeve 320 are not largely separated from each other and the shortest distance D2 therebetween is maintained, the shaft housing portion 340 is disposed close to the arc-like short side 321 of the sleeve 320. A distance D6 between the shaft housing portion 340 and each of the long sides 323 and 324 of the sleeve 320 is, for example, 0.5 mm.

The tunnel 310 has a shape close to a crescent shape as a whole. The tunnel 310 includes a recessed arc-like first end portion 313 corresponding to the inner side of a crescent shape (on the side close to the shaft housing portion 340) and a protruding arc-like second end portion 314 corresponding to the outer side of the crescent shape (on the side distant from the shaft housing portion 340). A distance D6 between the tunnel 310 and each of the long sides 323 and 324 of the sleeve 320 is, for example, 0.5 mm.

The first end portion 313 of the tunnel 310 includes a first arc portion 311. The first arc portion 311 is a portion in which a distance D1 in the X-direction from the shaft housing portion 340 (that is, the width of the rib 317 in the X-direction) is constant over a predetermined section in the Y-direction. In other words, the first arc portion 311 and the shaft housing portion 340 are separated from each other while maintaining the constant distance D1 via the rib 317. The distance D1 is, for example, 0.5 mm. Thus, in the state in which the first end portion 313 of the tunnel 310 and the shaft housing portion 340 are not largely separated from each other and the shortest distance D1 therebetween is maintained, the tunnel 310 and the shaft housing portion 340 are disposed adjacently to each other via the rib 317.

The second end portion 314 of the tunnel 310 includes a second arc portion 312. The second arc portion 312 is a portion in which a distance D3 in the X-direction from the shaft housing portion 340 is constant over a predetermined section in the Y-direction. The distance D3 is, for example, 2.0 mm. The first arc portion 311 and the second arc portion 312 of the tunnel 310 face each other in the X-direction. A distance D4 between the first arc portion 311 and the second arc portion 312 is a maximum width of the tunnel 310 in the X-direction and is, for example, 1.5 mm. A distance D5 between the second end portion 314 of the tunnel 310 and the arc-like short side 322 of the sleeve 320 is, for example, 0.5 mm. Thus, in the state in which the second end portion 314 of the tunnel 310 and the arc-like short side 322 of the sleeve 320 are not largely separated from each other and the shortest distance D5 therebetween is maintained, the tunnel 310 is disposed close to the arc-like short side 322 of the sleeve 320.

Both ends 315 and 316 of the tunnel 310 in the Y-direction are matched with both ends 341 and 342 of the shaft housing portion 340 in the Y-direction or are located inwardly relative to the both ends 341 and 342. Conversely, the both ends 315 and 316 of the tunnel 310 in the Y-direction do not stick out in the Y-direction relative to the both ends 341 and 342 of the shaft housing portion 340 in the Y-direction. This makes it possible to set the length of the sleeve 320 in the Y-direction to be a minimum length that allows the operating portion 330 to be housed, and possible to prevent the sleeve 320 from being increased in size in the Y-direction (that is, a reduction in thickness of the electronic apparatus 1 from being hindered).

In the sleeve 320 having the structure described above, the portion excluding the shaft housing portion 340 and the tunnel 310 has a minimum width (D1=D2=D6=0.5 mm). Consequently, the sleeve 320 having the limited size is provided with the space of the shaft housing portion 340, and then the area of the tunnel 310 is maximized. Specifically, the tunnel 310 is formed in a shape close to a crescent shape as a whole, and thus, for example, as compared with a case where the first end portion 313 of the tunnel 310 is assumed to be linear (the tunnel has a shape close to a semicircle instead of the crescent shape), the region between the shaft housing portion 340 and the tunnel 310 (the portion including the rib 317) can be used without waste, and the tunnel 310 can have a maximum area without increasing the size of the sleeve 320.

Preventing the sleeve 320 from being increased in size makes it possible to prevent the first waterproof component 600 and the second waterproof component 700 from being increased in size and installation locations thereof from being widened. In other words, the first waterproof component 600 and the second waterproof component 700 can be reduced in size, and the number of first waterproof components 600 and second waterproof components 700 can be reduced to be minimum. This is space-saving and contributes to the downsizing or reduction in thickness of the electronic apparatus 1. Further, the number of locations in which the first waterproof component 600 and the second waterproof component 700 are installed is minimized, and the area thereof is made small, so that a location in which the waterproof property may attenuate can be reduced and the area thereof can be made small accordingly.

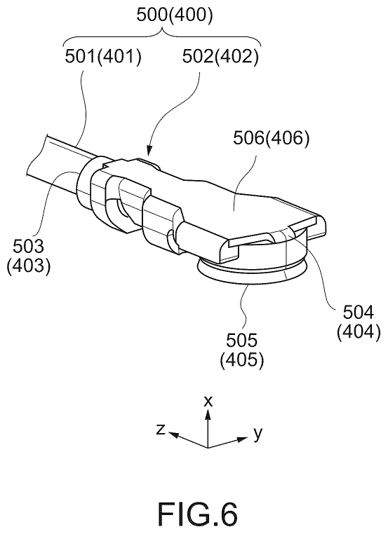

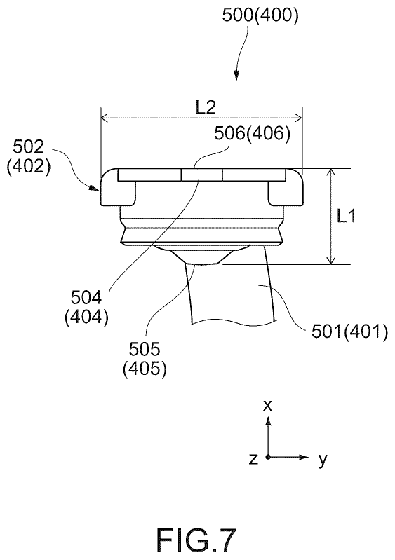

FIG. 6 is a perspective view of a connector of the cable unit. FIG. 7 is a front view of the connector of the cable unit.

The cable 501 is inserted into and connected to a connection end 503 of a connector 502 of the first cable unit 500. With a front end 504 opposite to the connection end 503 of the connector 502 being as the front, the connector 502 is inserted into the tunnel 310. A fitting end 505 is provided at one end in a fitting direction (x-direction) orthogonal to the insertion direction (z-direction). The fitting end 505 is fitted into the antenna board 205 in the fitting direction (x-direction) and connected thereto.

The direction of the connector 402 that is orthogonal to the insertion direction (z-direction) and the fitting direction (x-direction) will be referred to as a width direction (y-direction). The length of a top surface 506 in the width direction (y-direction) is longer than the length of the fitting end 505 in the width direction (y-direction). For example, a length L1 of the connector 502 in the fitting direction (x-direction) is 1.3 mm, a length L2 thereof in the width direction (y-direction) is 2.0 mm, and thus the length L1 in the fitting direction (x-direction) is shorter (L1<L2). The diameter of the cable 501 is, for example, 0.81 mm.

The cable 401 is inserted into and connected to a connection end 403 of a connector 402 of the second cable unit 400. With a front end 404 opposite to the connection end 403 of the connector 402 being as the front, the connector 402 is inserted into the tunnel 310. A fitting end 405 is provided at one end in the fitting direction (x-direction) orthogonal to the insertion direction (z-direction), and a top surface 406 is provided at the other end. The fitting end 405 is fitted into the antenna board 205 in the fitting direction (x-direction) and connected thereto.

The length of the top surface 406 in the width direction (y-direction) is longer than the length of the fitting end 405 in the width direction (y-direction). For example, a length L1 of the connector 402 in the fitting direction (x-direction) is 0.95 mm, a length L2 thereof in the width direction (y-direction) is 2.0 mm, and thus the length L1 in the fitting direction (x-direction) is shorter (L1<L2). The diameter of the cable 401 is, for example, 0.64 mm.

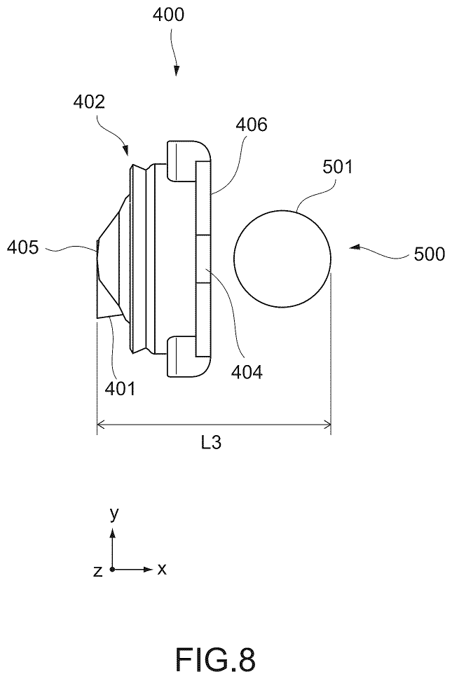

FIG. 8 schematically shows the connector of the first cable unit and the cable of the second cable unit.

The diameter of the cable 501 of the first cable unit 500 is 0.81 mm. The length L1 of the connector 402 of the second cable unit 400 in the fitting direction (x-direction) (a shorter length in the two directions (x-direction and y-direction) orthogonal to the insertion direction (z-direction)) is 0.95 mm. A total value L3 of the diameter of the cable 501 (0.81 mm), the length L1 of the connector 402 in the fitting direction (x-direction) (0.95 mm), and a clearance therebetween (0.2 mm) is 1.96 mm.

As described above, the maximum width D4 of the tunnel 310 in the X-direction is 1.5 mm. The maximum width D4 of the tunnel 310 in the X-direction (1.5 mm) is shorter than the total value L3 (1.96 mm). In other words, the size of the tunnel 310 is such a size that the connector 402 of the second cable unit 400 and the cable 501 of the first cable unit 500 cannot be inserted in the state of overlapping with each other in the x-direction.

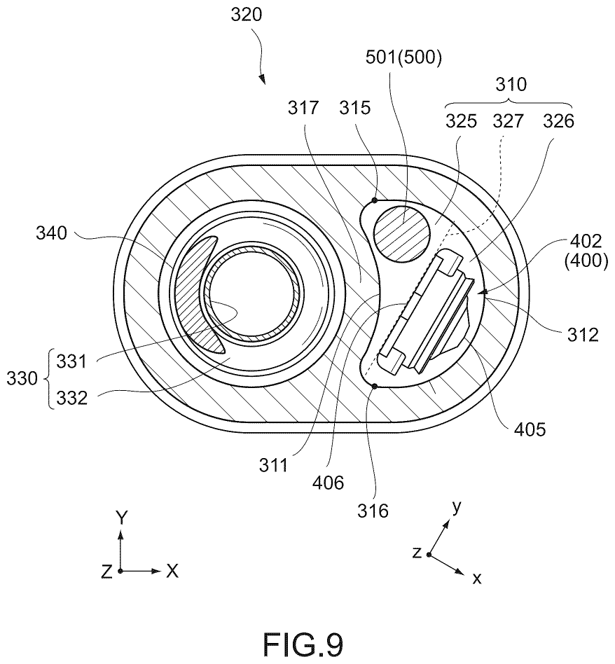

FIG. 9 is a diagram for describing a state in which the two cable units are inserted into the tunnel.

The tunnel 310 includes a cable region 325 and a connector region 326. The cable region 325 is a space for housing the cable 501 of the first cable unit 500. The connector region 326 is a space for inserting the connector 402 of the second cable unit 400 in a state in which the cable 501 of the first cable unit 500 is housed in the cable region 325.

The cable region 325 and the connector region 326 are spatially identical (that is, a space within the tunnel 310), but may be divided by a boundary line 327 that is a virtual straight line. The boundary line 327 coincides with a straight line passing on the top surface 406 of the connector 402 of the second cable unit 400 and virtually extending in the width direction (y-direction) of the connector 402. The boundary line 327 (y-direction) inclines relative to the X-direction and the Y-direction (that is, the direction of the long sides 323 and 324 of the sleeve 320, the Y-direction, and the direction of the short sides 321 and 322).

The cable region 325 includes one end 315 of the tunnel 310 in the Y-direction and a portion of the first arc portion 311 on the one end 315 side, and is partitioned by the boundary line 327. The connector region 326 includes another end 316 of the tunnel 310 in the Y-direction, a portion of the first arc portion 311 on the other end 316 side, and the second arc portion 312, and is partitioned by the boundary line 327.

When the first cable unit 500 and the second cable unit 400 are caused to pass through the tunnel 310, first, the first cable unit 500 is inserted into the tunnel 310 from the connector 502, and the connector 502 is drawn from the tunnel 310. With the cable 501 being moved close to the one end 315 of the tunnel 310 in the Y-direction, the cable 501 is housed in the cable region 325 of the tunnel 310. Next, with the cable 501 being housed in the cable region 325, the second cable unit 400 is inserted in the connector region 326 of the tunnel 310 from the connector 402, the connector 402 is drawn from the tunnel 310, and the cable 401 is housed in the tunnel 310.

This makes it possible to insert the first cable unit 500 and the second cable unit 400 into the tunnel 310 (FIG. 9), irrespective of the fact that the tunnel 310 has such a size that the connector 402 of the second cable unit 400 and the cable 501 of the first cable unit 500 cannot be inserted in the state of overlapping with each other in the x-direction (FIG. 8).

Reducing the size of the tunnel 310 and thus reducing the size of the sleeve 320 make it possible to prevent the first waterproof component 600 and the second waterproof component 700 from being increased in size and installation locations thereof from being widened. In other words, the first waterproof component 600 and the second waterproof component 700 can be reduced in size, and the number of first waterproof components 600 and second waterproof components 700 can be reduced to be minimum. This is space-saving and contributes to the downsizing or reduction in thickness of the electronic apparatus 1. Further, the number of locations in which the first waterproof component 600 and the second waterproof component 700 are installed is minimized, and the area thereof is made small, so that a location in which the waterproof property may attenuate can be reduced and the area thereof can be made small accordingly.

Note that both of the two cable units are assumed to have the size of the second cable unit 400 (have the same size). In other words, the length L1 of the connector 402 in the fitting direction (x-direction) is 0.95 mm, the length L2 thereof in the width direction (y-direction) is 2.0 mm, and the diameter of the cable 401 is 0.64 mm. In this case, a total value L3 of the diameter of the cable 401 (0.64 mm), the length L1 of the connector 402 in the fitting direction (x-direction) (0.95 mm), and the clearance therebetween (0.2 mm) is 1.79 mm. The maximum width D4 of the tunnel 310 in the X-direction (1.5 mm) is shorter than the total value L3 (1.79 mm). In other words, the size of the tunnel 310 is such a size that the connector 402 of the second cable unit 400 and the cable 401 of the second cable unit 400 cannot be inserted in the state of overlapping with each other in the x-direction. However, the two second cable units 400 can be inserted into the tunnel 310 by the same method as that described above.

Hereinabove, the single pop-up portion 200 (single shaft unit 300 and one set of cable units 400 and 500) has been described. However, actually, the electronic apparatus 1 includes the two pop-up portions 200 (top-side pop-up portion 200A and bottom-side pop-up portion 200B). Thus, the electronic apparatus 1 includes two shaft units 300 and two sets of cable units 400 and 500, which respectively provided to the two pop-up portions 200 (top-side pop-up portion 200A and bottom-side pop-up portion 200B).

As described above, in this embodiment, in the structure in which the pop-up portion 200 and the main body portion 100 are connected to each other, the compatibility between the waterproof property at the connection location and the downsizing or reduction in thickness can be achieved.

The present disclosure may take the following configurations.

(1) An electronic apparatus, including:
a main body portion that includes a first component;
a pop-up portion that includes a second component and is capable of being housed in the main body portion and capable of popping up from the main body portion in a first direction;
a shaft unit including
   a sleeve that is movably connected to one of the main body portion and the pop-up portion and fixedly connected to another one of the main body portion and the pop-up portion and is movable in the first direction, and
   a tunnel that penetrates the sleeve in the first direction,
the shaft unit moving the pop-up portion in the first direction relative to the main body portion; and
a cable unit that passes through the tunnel to connect the first component and the second component to each other.

(2) The electronic apparatus according to (1), in which
the shaft unit further includes
   an operating portion that moves the pop-up portion in the first direction relative to the main body portion, and
   a shaft housing portion that penetrates the sleeve in the first direction and houses the operating portion, and
in a cross-section of the shaft unit, the cross-section being orthogonal to the first direction,
the tunnel and the shaft housing portion are adjacent to each other in a second direction orthogonal to the first direction, and
in a third direction orthogonal to the first direction and the second direction, both ends of the tunnel in the third direction are matched with or located inwardly relative to both ends of the shaft housing portion in the third direction.

(3) The electronic apparatus according to (2), in which
in the cross-section of the shaft unit, the cross-section being orthogonal to the first direction,
the shaft housing portion is circular,
the tunnel includes a first end portion on a distant side of the tunnel from the shaft housing portion, and
the first end portion includes a first arc portion in which a distance in the second direction from the shaft housing portion is constant over a predetermined section in the third direction.

(4) The electronic apparatus according to (2) or (3), in which
in the cross-section of the shaft unit, the cross-section being orthogonal to the first direction,
the tunnel includes a second end portion on a distant side of the tunnel from the shaft housing portion, and
the second end portion includes a second arc portion in which a distance in the second direction from the shaft housing portion is constant over a predetermined section in the third direction.

(5) The electronic apparatus according to any one of (1) to

(4), in which
the cable unit includes
   a cable, and
   a connector that connects the cable to the first component or the second component.

(6) The electronic apparatus according to any one of (1) to

(5), in which
the electronic apparatus includes two cable units that are a first cable unit and a second cable unit.

(7) The electronic apparatus according to (6), in which
a maximum width of the tunnel in the second direction is shorter than a sum of a diameter of the cable of the first cable unit and a shorter length of lengths of the connector of the second cable unit in two directions orthogonal to a direction in which the connector of the second cable unit is inserted into the tunnel.

(8) The electronic apparatus according to (7), in which
the shorter length of the lengths of the connector of the second cable unit in the two directions is a length of the connector of the second cable unit in a fitting direction relative to the first component or the second component.

(9) The electronic apparatus according to any one of (6) to

(8), in which
in a cross-section of the shaft unit, the cross-section being orthogonal to the first direction,
the tunnel includes
   a cable region in which the cable of the first cable unit is housed, and
   a connector region in which the connector of the second cable unit is inserted in a state in which the cable of the first cable unit is housed in the cable region, and
a boundary line between the cable region and the connector region inclines relative to the second direction and the third direction.

(10) The electronic apparatus according to any one of (1) to

(9), in which
the first component is a substrate, and
the second component is an antenna unit.

(11) The electronic apparatus according to any one of (1) to

(10), in which
the main body portion and the pop-up portion are waterproof.

(12) The electronic apparatus according to any one of (1) to

(11), further including:
a first waterproof component provided between the main body portion and the sleeve; and
a second waterproof component provided between the pop-up portion and the sleeve.

(13) The electronic apparatus according to any one of (1) to

(12), in which
a surface orthogonal to the first direction of the main body portion is covered with the pop-up portion.

(14) The electronic apparatus according to any one of (1) to

(13), in which
the pop-up portion includes a speaker, a camera lens, and/or a microphone.

(15) The electronic apparatus according to any one of (1) to

(14), further including:
two of the pop-up portion that face each other in the first direction relative to the main body portion; and
two of the shaft unit and two sets of the cable unit that are provided to the respective two pop-up portions.

The embodiments and modified examples of the present technology have been described above, but the present technology is not limited to the embodiments described above and can be variously modified without departing from the gist of the present technology.

### Reference Signs List

1 electronic apparatus
100 main body portion
101 main surface
102 short side
103 short side
104 long side
105 long side
106 touch panel
107 top surface
108 bottom surface
109 main substrate
110 casing end portion
200 pop-up portion
200A top-side pop-up portion
200B bottom-side pop-up portion
201 speaker
202 camera lens
203 speaker
204 antenna unit
204A top-side antenna unit
204B bottom-side antenna unit
205 flexible printed board
206 antenna metal
206A top-side antenna metal
206B bottom-side antenna metal
210 casing end portion
300 shaft unit
310 tunnel
311 first arc portion
312 second arc portion
313 first end portion
314 second end portion
315 one end
316 another end
320 sleeve
321 short side
322 short side
323 long side
324 long side
325 cable region
326 connector region
330 operating portion
331 shaft
332 coil spring
340 shaft housing portion
341 both ends
400 second cable unit
401 cable
402 connector
403 connection end
404 front end
405 fitting end
406 top surface
500 first cable unit
501 cable
502 connector
503 connection end
504 front end
505 fitting end
600 first waterproof component
700 second waterproof component
800 motor claims

1. An electronic apparatus, comprising:
a main body portion that includes a first component;
a pop-up portion that includes a second component and is capable of being housed in the main body portion and capable of popping up from the main body portion in a first direction;
a shaft unit including
a sleeve that is movably connected to one of the main body portion and the pop-up portion and fixedly connected to another one of the main body portion and the pop-up portion and is movable in the first direction, and
a tunnel that penetrates the sleeve in the first direction,
the shaft unit moving the pop-up portion in the first direction relative to the main body portion; and
a cable unit that passes through the tunnel to connect the first component and the second component to each other.

2. The electronic apparatus according to claim 1, wherein
the shaft unit further includes
an operating portion that moves the pop-up portion in the first direction relative to the main body portion, and
a shaft housing portion that penetrates the sleeve in the first direction and houses the operating portion, and
in a cross-section of the shaft unit, the cross-section being orthogonal to the first direction,
the tunnel and the shaft housing portion are adjacent to each other in a second direction orthogonal to the first direction, and
in a third direction orthogonal to the first direction and the second direction, both ends of the tunnel in the third direction are matched with or located inwardly relative to both ends of the shaft housing portion in the third direction.

3. The electronic apparatus according to claim 2, wherein
in the cross-section of the shaft unit, the cross-section being orthogonal to the first direction,
the shaft housing portion is circular,
the tunnel includes a first end portion on a distant side of the tunnel from the shaft housing portion, and
the first end portion includes a first arc portion in which a distance in the second direction from the shaft housing portion is constant over a predetermined section in the third direction.

4. The electronic apparatus according to claim 2, wherein
in the cross-section of the shaft unit, the cross-section being orthogonal to the first direction,
the tunnel includes a second end portion on a distant side of the tunnel from the shaft housing portion, and
the second end portion includes a second arc portion in which a distance in the second direction from the shaft housing portion is constant over a predetermined section in the third direction.

5. The electronic apparatus according to claim 1, wherein
the cable unit includes
a cable, and
a connector that connects the cable to the first component or the second component.

6. The electronic apparatus according to claim 1, wherein
the electronic apparatus includes two cable units that are a first cable unit and a second cable unit.

7. The electronic apparatus according to claim 6, wherein
a maximum width of the tunnel in the second direction is shorter than a sum of a diameter of the cable of the first cable unit and a shorter length of lengths of the connector of the second cable unit in two directions orthogonal to a direction in which the connector of the second cable unit is inserted into the tunnel.

8. The electronic apparatus according to claim 7, wherein
the shorter length of the lengths of the connector of the second cable unit in the two directions is a length of the connector of the second cable unit in a fitting direction relative to the first component or the second component.

9. The electronic apparatus according to claim 6, wherein
in a cross-section of the shaft unit, the cross-section being orthogonal to the first direction,
the tunnel includes
a cable region in which the cable of the first cable unit is housed, and
a connector region in which the connector of the second cable unit is inserted in a state in which the cable of the first cable unit is housed in the cable region, and
a boundary line between the cable region and the connector region inclines relative to the second direction and the third direction.

10. The electronic apparatus according to claim 1, wherein
the first component is a substrate, and
the second component is an antenna unit.

11. The electronic apparatus according to claim 1, wherein
the main body portion and the pop-up portion are waterproof.

12. The electronic apparatus according to claim 1, further comprising:
a first waterproof component provided between the main body portion and the sleeve; and
a second waterproof component provided between the pop-up portion and the sleeve.

13. The electronic apparatus according to claim 1, wherein
a surface orthogonal to the first direction of the main body portion is covered with the pop-up portion.

14. The electronic apparatus according to claim 1, wherein
the pop-up portion includes a speaker, a camera lens, and/or a microphone.

15. The electronic apparatus according to claim 1, further comprising:
two of the pop-up portion that face each other in the first direction relative to the main body portion; and
two of the shaft unit and two sets of the cable unit that are provided to the respective two pop-up portions.
